(19) United States
(12) Patent Application Publication
(10) Pub. No.: US 2003/0072057 A1
(43) Pub. Date: Apr. 17, 2003

(54) Virtual common space: using WDM in metro access networks

(75) Inventors: Nicholas J. Frigo, Little Silver, NJ (US); Mark W. Stodden, Red Bank, NJ (US)

Correspondence Address: AT&T CORP., P.O. BOX 4110, MIDDLETOWN, NJ, 07748, US

(73) Assignee: AT&T Corp., New York, NY

(21) Appl. No.: 10/127,195

(22) Filed: Apr. 22, 2002

Related U.S. Application Data
(60) Provisional application No. 60/329,564, filed on Oct. 15, 2001.

(51) Int. Cl. H04J 14/02; H04B 10/00

(52) U.S. Cl. 359/125; 359/167

(57) ABSTRACT

A system and method utilizing inexpensive “Coarse” WDM (CWDM) components to extend the economic utility of a service provider's local network service (LNS) feeder fiber used to serve business customers. Using these existing components and a hybrid of PON and SONET technologies, the invention provides many of the advantages of “Common Space” equipment through optical in lieu of electronic multiplexing. The technique reduces access costs, decreases provisioning time, reduces capital expenditures, and enables more aggressive marketing for local business services.

This application claims priority to Provisional Application Serial No. 60/329,564 entitled “VIRTUAL COMMON SPACE: USING WDM IN METRO ACCESS NETWORKS” filed on Oct. 15, 2001, the content of which is incorporated by reference herein.

### FIELD OF THE INVENTION

The present invention relates generally to telecommunications access networks, and more particularly, to the use of wave division multiplexing (WDM) components to increase the economic utility of local network services feeder fiber used to serve customer premises by a network service provider.

### BACKGROUND

Access to business customers from a service provider's Local Network Services (LNS), such as, for example, AT&T, is often accomplished through the use of SONET rings. Customers served in this manner are typically large enough that they have a fiber connection to their premises (“On-Net”) to deliver the required high capacity. In principle, one desires these rings to be populated with several nodes to make use of the fiber plant. That is, the node or local serving office (LSO) serves as a hub, aggregating traffic from the terminals comprising the customer premise equipment (CPE) on the client side, and connecting to the service provider's network on the line side. In practice, however, the customer access rings often comprise only two nodes, the terminals in the LSO and the CPE for a single user. One reason for this is that it is unlikely that a second customer (who might be a logical candidate for that ring) will come on line at the same time as the first customer on the ring. This leaves the options of either stranding terminal equipment at non-customer sites or installing new fiber for the second customer. Current strategy, business practices, and accounting constraints favor the latter approach. Such installations are called “Fiber-to-the-floor” (FTTF) since the fiber connection is usually run from the node or LSO into the building, up riser space to the floor on which the customer resides, and to the customer's CPE. However, this practice leads to an undesirable situation (FIG. 1a) in which several customers, each disposed on a different floor of a given building, may have independent fiber runs to their floors.

A more advantageous solution is to acquire “common space” in a large building if it holds many customers and to install high speed multiplexing equipment in that space. “Common space” (CS) refers to an area, located typically in the basement of a large building, in which a telecommunications provider can install multiplexers and other communications equipment. In this case, the service provider's LNS becomes a tenant of the building and leases space from the landlord for the placement of the “common” equipment. The service provider has access to the space for maintenance purposes. The equipment configuration includes a rectifier and battery plant with a specified number of hours of reserve power. This is much more restrictive for the LNS than FTTF applications, in which the service provider requires the customer to provide space and power for any required equipment. The common space approach, shown in FIG. 1b, trades off the cost of high-speed multiplexing equipment (which scales sublinearly in the number of users) for a savings in feeder fiber, which scales linearly in the number of users. As new users appear, they can be connected to the add/drop multiplexer in the common space for the cost of a line card, the CPE, and the riser cables. (Most services at DS1 and DS3 rates are carried over twisted pair and coaxial cables, respectively.)

It is not always possible to use common space, however, as a result of the difficulty and/or cost in obtaining the rights from the owner of the common space, i.e., the landlord. This can lead to unfortunate situations in which dozens of fibers, from dozens of independent rings, enter a large building, each terminating on a different customer's premise. In addition to the direct cost of this fiber, there are opportunity costs associated with fiber exhaust of the existing Local fiber backbone and the diversion of building resources from other projects with other potential customers.

Even in cases in which common space is possible, there are drawbacks to common space applications inherent to the riser system that is built between the drop side of the optical transmission equipment and the customer demarcation point. Typically, this riser is built with unshielded twisted pair copper cables and is primarily designed for carrying multiple DS1 signals from the client side of the common space equipment up to the customer's equipment. This riser system can become extremely expensive as the size of the building increases. As the number of floors increases, the quantity of pairs in the riser system increases, necessitating larger and larger conduit. In large buildings it is possible to require a four-inch conduit to traverse 50 floors in a high-rise building with high construction costs. If DS3 coaxial cables are included in this riser system, the conduit size grows even faster due to the larger cable diameter with concomitant increase in expense. Also, DS3 signals have a distance limitation of approximately 400 ft. using standard mini-coaxial cable. This distance can be increased, but only by using even larger diameter coaxial cable, further increasing the conduit requirements and costs. As time goes on, it is possible to encounter buildings with such riser congestion conditions that only fiber riser systems can be deployed. Furthermore, as services evolve to higher bandwidths, fiber risers will become necessary for the transmission of OC-X and Gigabit Ethernet services. This will drive additional riser space requirements for this third transmission medium. Thus, approaches that emphasize fiber risers will ultimately help in reducing installation costs (because of the fiber medium) and in providing broadband access in the future for higher bandwidth services.

On-Net connections to large customers are typically made using a conventional two-node, two-fiber Unidirectional Path-Switched Ring (UPSR), an exemplary layout of which is depicted in FIG. 2. Each terminal has two transmitters, each sending the same information, and two receivers. Data flows in one direction in each ring: in this case, clockwise in the upper ring and counter-clockwise in the lower ring. The terminals sense when the optical power to a receiver drops below a trigger level (e.g. lower than the other receiver's power, or lower than a pre-determined threshold) and then throws a protection switch, going to the other receiver for its data. If the fibers are diversely routed such a scheme protects against fiber failures as well as transmitter and receiver failures. For the purpose of illustration herein, this arrangement is depicted in FIG. 3 with solid lines as the “working” fibers and dashed lines as the “protection” fibers.

When new users in a given building are added to the network, each has a FTTF run as shown schematically in FIG. 1. As each customer is brought On-Net in accordance with the usual methodology, another set of fibers in the set of conduits (e.g. under the streets) is assigned to that building and another FTTF connection is made, as shown schematically in FIG. 4. Since each user requires 4 feeder fibers (e.g. two fibers on each of two sides of the ring), and each fiber must run all the way from the LSO to the building, the costs can be substantial. In an exemplary application, assuming fiber costs per mile of $300K for a 144-fiber cross-section, it costs approximately $2000/fiber mile. If the average ring size is taken as 10 miles, this means that each new FTTF customer consumes on the order of $40,000 in fiber costs.

### SUMMARY OF THE INVENTION

In accordance with the present invention, it is an object thereof to utilize relatively inexpensive WDM technologies (i.e., components separate wavelengths of light on a much coarser (and hence less expensive) scale than the dense WDM (DWDM) components with standardized and tightly controlled wavelengths that are used in long-haul and metropolitan network equipment) to provide common space advantages even when common space is denied to a service provider or is considered economically unattractive.

It is another object of the invention to reduce build costs, extend the economic utility of the service provider's local backbone fiber plant, and thus open a much larger potential customer base for the service provider's Local Services business. This approach can be as advantageous as a common space in lowering costs by exploiting the capacity of the outside fiber plant. This technique, which is referred to herein as a “Virtual Common Space” (VCS), can be implemented on a very short time scale from a technology viewpoint since it uses equipment similar to current products, and it can reduce time-to-service delays associated with negotiating and implementing common space agreements.

The present invention provides a VCS using wave division multiplexing (WDM) in access networks that serve a customer premises. The VCS can be implemented in those situations in which it is impossible or impractical for a common space to be obtained in a customer premises. The use of WDM provides the “virtual” attribute: This provides the advantage of “fiber gain,” but without the need for common space power, control, security, or real estate. Depending on the distribution of customers, this methodology can be cost-competitive with the common space strategy, by capturing the majority of the Outside Plant (OSP) savings and eliminating the cost associated with leasing the common space, but without the rate-scaling savings of electrical multiplexing possible if the Common Space equipment were fully utilized.

In accordance with one aspect of the present invention, there is provided a method of communicating between a node or local serving office (hereinafter referred to as an “office”) and a plurality of customer premises equipment, comprising the steps of: transmitting signals at wavelengths λ₁ to λₙ from the office over a link to a plurality of multiplexers; multiplexing the signals from the local serving office into a set of transmission fibers; receiving the multiplexed signals at a plurality of demultiplexers; distributing the demultiplexed signals at wavelengths λ₁ to λₙ to a corresponding N links terminating on receivers associated with the customer premises equipment; and receiving signals at wavelengths λ₁ ′ to λₙ ′ from the customer premises equipment at a plurality of multiplexers; multiplexing the signals from the customer premises equipment into a second transmission fiber; receiving the multiplexed signals from the customer premises equipment at a plurality of demultiplexers; distributing the demultiplexed signals from the customer premises equipment at wavelengths λ₁ ′ to λₙ ′ to equipment in the local office, thereby forming a first ring carrying working traffic with at least two nodes (the office and the customer premises); and directing protection traffic through a second ring through a second transmission fiber set with two nodes connected to the local serving office, and two nodes connected to the customer premises equipment.

The present invention will now be described in detail with particular reference to the accompanying drawings.

### BRIEF DESCRIPTION OF THE DRAWINGS

FIG. 1 is a schematic of a typical FTTF arrangement;

FIG. 2 is a schematic of a conventional two-node USPR for On-Net connections;

FIG. 3 is a schematic of the USPR of FIG. 2, with solid lines indicating “working” fibers and dashed lines indicating “protection” fibers;

FIG. 4 is a schematic showing how new users are added to a building using the arrangement of FIG. 3;

FIG. 5 is an illustrative embodiment of a VCS system using WDM;

FIG. 6 shows the embodiment of FIG. 5, with working traffic communicated via an upper conduit and protection traffic communicated via the lower conduit;

FIG. 7 schematically depicts a fiber failure affecting a particular user terminal;

FIG. 8 schematically depicts a failure in the links to a particular user terminal;

FIG. 9 schematically depicts a fault in the upper conduit; and

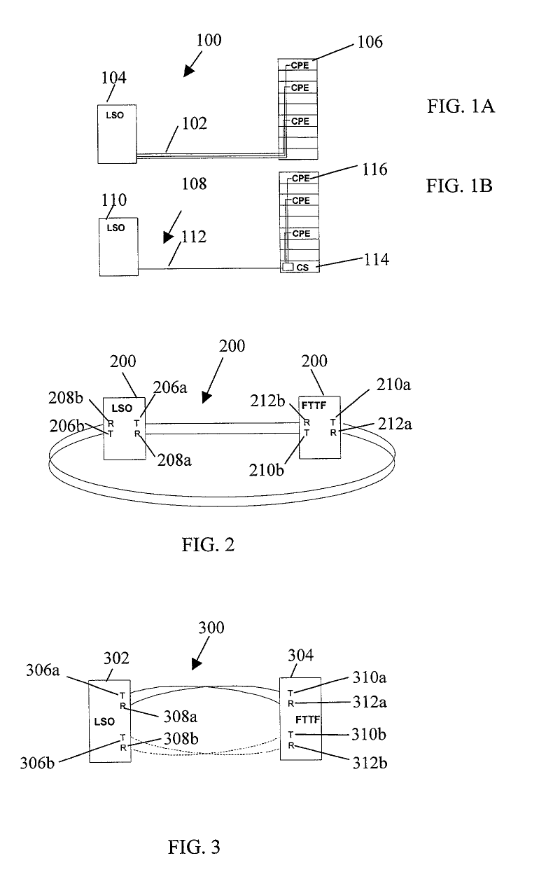

FIG. 1 0 is a schematic of an alternative embodiment.

### DETAILED DESCRIPTION OF THE PREFERRED EMBODIMENTS

Referring to FIG. 1A, there is depicted a typical Fiber-to-the floor (FTTF) arrangement characterized by the reference numeral 100. Fiber connections 102 run from the local serving office (LSO) 104 into the building, and typically up riser space to the floor on which the customer resides, and to the customer premises equipment (CPE) indicated collectively as 106. Several customers, each on different floors, may have independent fiber runs using this arrangement. FIG. 1B depicts a common space approach 108, in which fiber from the LSO 110 is run into the building (shown generally as 112) to a common space 114. Add/drop multiplexers are utilized to feed the signals from the common space 114 to CPE(s)116.

Referring now to FIG. 2, there is depicted a conventional 2-node Unidirectional Path-Switched Ring (USPR) layout 200 for On-Net connections. Each LSO terminal 202 and FTTF terminal 204 has a pair of transmitters and receivers. LSO terminal 202 has transmitters 206a, 206b (each transmitting the same data) and receivers 208a, 208b. Similarly, FTTF terminal 204 has transmitters 210a, 210b (each transmitting the same data) and receivers 212a, 212b. Data flows in one direction in each ring. The data in the upper ring flows clockwise and the data in the lower ring flows counterclockwise. The terminals sense when the optical power to a working receiver drops below a trigger level (e.g. lower than the other receiver's power, or lower than a pre-determined threshold) and then throws a protection switch, going to the other (protection) receiver for its data. If the fibers are diversely routed such a scheme protects against fiber failures as well as transmitter and receiver failures.

Referring now to FIG. 3, the arrangement depicted in FIG. 2 is rearranged for clarity with the solid lines indicating “working” fibers and the dashed lines representing “protection” or back-up routing fibers. Here, the USPR 300 has an LSO 302 with transmitters 306a, 306b and receivers 308a, 308b. The FTTF 304 has transmitters 310a, 310b and receivers 312a, 312b. Transmitters 306a, 306b in LSO 302 are coupled to receivers 312a, 312b, respectively, in FTTF 304. Likewise, transmitters 310a, 310b are coupled to receivers 308a, 308b in LSO 302. If the fibers connecting transmitter/receiver pairs 306a, 312a and 306b, 312b, respectively, suffer from failure, signals are rerouted through the fibers connecting transmitter/receiver pairs 306b, 312b and 310b, 308b, respectively.

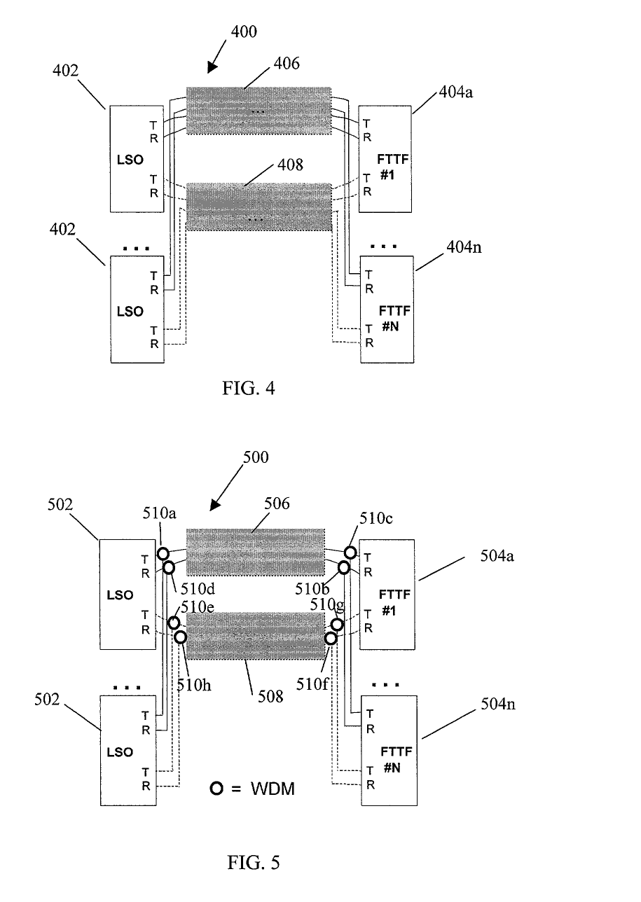

Referring now to FIG. 4, new users are added to a particular building, each having a FTTF run as shown schematically in the drawing. Specifically, as each customer is brought On-Net utilizing the typical method, another set of fibers disposed in conduits (e.g., under the street) is assigned to the building an additional FTTF connection is made between the LSO and the FTTF. In FIG. 4, implementation 400 is depicted bridging LSO terminals 402 to FTTF terminals 404a . . . 404n. Each LSO terminal 402 has a pair of transmitters and receivers T, R, respectively. (While shown separately, there is the possibility that multiple terminals 402 can be part of a single piece of equipment.) Likewise, each FTTF 404a . . . 404n has a pair of transmitters and receivers T, R, respectively. Each user (FTTF) has 4 feeder fibers, a first pair for “working” traffic, and a second pair for backup protection. LSO terminal 402 is connected to FTTF 404a in the same manner depicted in FIG. 3 via conduits 406 and 408 respectively carrying the working and backup elements. LSO 402 is similarly connected to FTTF 404n.

Referring now to FIG. 5, there is depicted an illustrative embodiment of a VCS system 500 using WDM. LSO 502 is connected to FTTF 504a . . . 504n. LSO 502 has a plurality of pairs of transmitters and receivers T, R, respectively, each pair adapted to operate in a specified wavelength band. Likewise, each FTTF 504a . . . 504n has a plurality of pairs of transmitters and receivers T, R, respectively, with each pair similarly adapted to operate in specified wavelength bands. Each user (FTTF) has 4 feeder fibers, a first pair for “working” traffic, and a second pair for backup protection. LSO 502 is connected to FTTF 504a via conduits 506 and 508 such that two rings, each of two nodes, are connected, with the left two nodes in the LSO 502 and the right two nodes in a large building. Each terminal has a significant throughput, i.e. OC-3 for example. WDM multiplexers and demultiplexers (M/D) characterized by the reference numeral 510 are disposed on the rings so that each transmitter T operates on a specified wavelength band to multiplex light from that transmitter onto the feeder fibers. For the sake of brevity, the issue of whether this wavelength originates rid from transmitter lasers in the terminal or from an auxiliary optical transponder that effectively translates the terminal's wavelength to the correct band is not addressed here. (Optical transponders convert an incoming optical signal from one laser to electrical form, and then use that electrical signal to drive a second optical laser. Since the two lasers are independent, the wavelength of the second laser is arbitrary, and can be chosen to match a desired WDM channel.)

This arrangement enables other fibers in the conduits shown in FIG. 4 to be made available for other revenue-generating uses. The cost of WDM components is inversely related to their wavelength tolerances. Dense Wavelength Division Multiplexing (DWDM) components, with tolerances on the order of 10 GHz or 0.1 nm, can be utilized, although they are far more expensive than “coarse” WDM (CWDM) components with tolerances of several nm. CWDM can be used in this application, operating in wavelength bands on the order of 5-10 nm in spectral width.

Leaving aside the issue of wavelength assignment for the moment, assume that the wavelength carrying data between the LSO and CPE for user “i” is λᵢ, so that LSO “working” transmitters T from λ₁ through λₙ are multiplexed by the top left WDM multiplexer 510a into a transmission fiber in the top conduit (506). After passing through the conduit 506 to the users' building, the wavelengths are demultiplexed by WDM demultiplexer 510b and distributed to the corresponding N “working” receivers (R) at the N customer terminals (FTTF 504a . . . 504n). In the same manner, the transmitters in the FTTF 504a . . . 505n are connected to the receivers in the LSO via WDM multiplexer 510c and demultiplexer 510d to complete the active ring. The protection fibers are similarly connected through conduit 508 via WDM multiplexer 510e and demultiplexer 510f and symmetrically through WDM multiplexer 510g and demultiplexer 510h. The transmitter wavelengths are matched (i.e., aligned) to the respective ports on the multiplexers, and the demultiplexers are similarly matched to the multiplexers. All other symmetries (LSO/CPE, working/protection) are unconstrained.

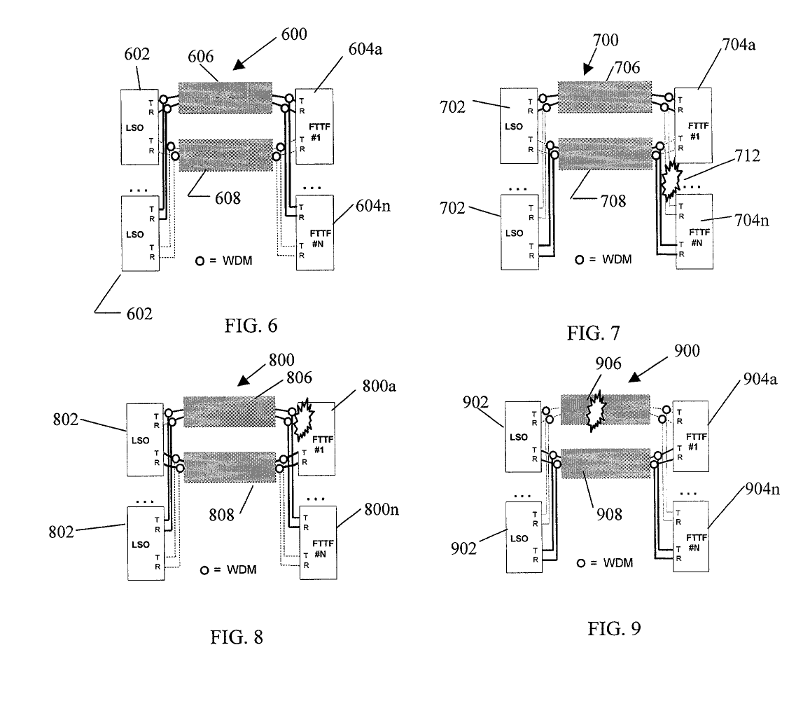

WDM enables each wavelength to define a ring. Consequently, the UPSR protocol enables each terminal pair (i.e. LSO/CPE #i) to behave as if it were on its own independent ring even though multiple users share common fiber. Referring now to FIG. 6-9, the same numbering convention as FIG. 5 has been utilized for clarity. In FIG. 6, the user terminals are arranged such that all the “working” traffic (represented by the solid lines) is communicated through the top conduit 606 between the LSO 602 and FTTF 604a . . . 604n. As discussed above, traffic is also transmitted on the dashed lines via the lower conduit 608, but this is considered to be “protection traffic” that is used by the system should a fiber failure occur. FIG. 7 depicts a fiber failure (such as a local failure near the terminal) at 712 that affects only user #N (704n). The UPSR protocol switches over to the protection circuit, so that now the live traffic (represented by the solid lines) is carried via the lower conduit 708. The traffic for user #1 (704a) is uninterrupted and continues to be communicated via the upper conduit 706. The issue of when the traffic on the backup protection circuit “reverts” to the original conduit when the fiber link has recovered is not addressed here.

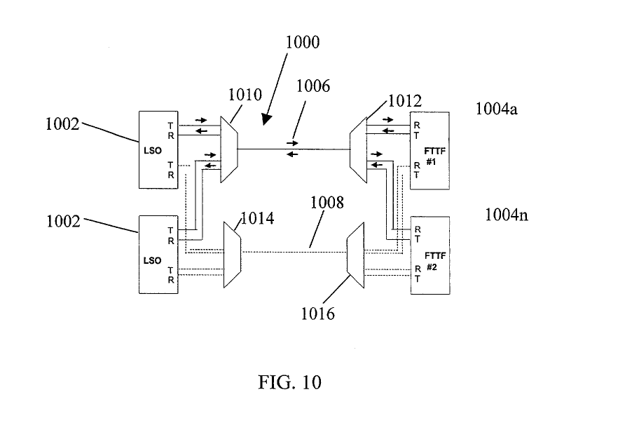

Referring again to the initial condition depicted in FIG. 6 where both circuits carry traffic in the upper conduit 606. FIG. 8 schematically depicts a failure 812 in the links to CPE #1 (804a). The working traffic for the lower CPE (804n) continues to traverse the upper conduit 806, while the upper CPE (804a) throws a protection switch and thereafter looks for live traffic in the lower conduit 808. Referring again to the initial condition of FIG. 6, if a failure of the entire conduit occurs, each of the rings experiences a failure, and each ring will throw a protection switch such that the entire traffic load traverses the lower conduit as shown in FIG. 9. Specifically, the upper conduit 906 has a fault represented at 912. All traffic is directed to the lower conduit 908 as represented by the heavy solid lines. Thus, in accordance with the conventional USPR protocols, each ring acts as if it operates on its own independent fiber, and will consequently redirect the traffic when it detects a failure.

In conjunction with other technology advances that are being developed for the metro network, the VCS can offer significantly decreased customer access costs. The availability of small inexpensive multiplexers (with optical interfaces) for deployment at a customer premises, may significantly reduce the cost penalty for individual multiplexers in multiple FTTF deployments. These multi-service platform (MSP) devices are designed to hub into a shared host terminal in the LSO. The LSO equipment has optical interfaces that can drive these subtending rings formed by FTTF customers. This spreads the cost of the host terminal common equipment across many customer locations and possibly a backbone system. The incremental costs to add a customer in an On-Net building include those of the CPE multiplexer, low-cost CWDM gear, a fiber riser to the customer premise and a circuit pack in the host terminal (MSP). The Optical Line Unit in the Host can be shared as well. Thus, placing small (on the order of 10 cubic inch) CWDMs in the building reduces fiber consumption associated with FTTF access arrangements. The ability to build cost effective FTTF applications can also improve the service delivery interval by eliminating the lease negotiation associated with common space arrangements.

In summary, the virtual common space (VCS) approach is a hybrid system with elements of (1) optical line systems (OLSs) that use DWDM, (2) passive optical networks (PONs), and (3) conventional SONET rings. First, VCS is like an OLS in that multiple streams of high-speed data are carried on multiple wavelengths to a wavelength demultiplexer at a remote location. Second, WDM PON technology is evident in that the wavelength carriers are independent: they go to different users (instead of a single OLS terminal), the users are remote from the WDM splitter as they are connected to it by (potentially lengthy) fiber runs, and the data streams are completely independent in that they are connected to different equipment operating at different wavelengths bearing different formats and services. Services on each of these wavelengths can be upgraded independently up to the capacity of the fiber. By using loose spectral bands in the initial deployment, a hierarchical DWDM overlay can be installed at a later date by subdividing the spectrum to a given user, reminiscent of a multiple-star approach to WDM PONs as disclosed in U.S. Pat. No. 5,808,764, entitled “Multiple star, passive optical network based on remote interrogation of terminal equipment,” the disclosure of which is incorporated by reference herein.

Finally, the layout has an underlying SONET ring structure, which can be used to provide conventional protection mechanisms that are customary in business applications. In this regard, each user's terminal equipment believes that it is on its own UPSR, and it makes its own protection decisions independently of any other terminal equipment. In this expedient, a layer of network elements (the ADM) are removed from the common space approach, by moving that function to the LSO.

The virtual common space: (1) reduces feeder fiber expenses; (2) avoids expenses associated with leasing a common space in a building (the optics are passive and small enough to fit into a pull-box), and (3) places minimal limitations on future upgrade paths. These advantages are somewhat offset by some costs specific to this implementation. First, the terminal costs are expected to be higher, since generally it is cheaper to have one terminal at rate NB than to have N terminals at rate B. While the CPE equipment is about the same for the two cases, depending on the type of traffic and the switching done in the LSO, it may be cheaper to have two multiplexers (in the LSO and CS) than to have N terminals in the LSO. This penalty for additional multiplexing equipment is expected to decrease as access architectures evolve to include more efficient customer arrangements such as those embodied in some of the new MSP equipment.

Second, the system uses CWDM optics as opposed to unspecified wavelengths. While providing a clearer upgrade path, this also has an impact both in the cost of CWDM optics and in operations. The optics cost penalty is expected to be minimal. The rapid emergence of low-cost WDM components with reduced wavelength restrictions is driving the cost down to levels comparable to those of conventional optics. Indeed, today the piece-parts cost for the optics in the Figures is dropping rapidly. As mentioned above, because the accuracy of this equipment is so much less stringent than conventional DWDM optics used in existing optical line systems (OLS), it is perhaps more useful to consider the transmitters as operating in a band rather than at a precisely specified wavelength.

Operational costs are more difficult to quantify. When a CWDM is installed and the fiber from one of its ports is sent up to, for example, the fourth floor of a building, the wavelength of the laser located on the fourth floor must correspond to that port. Thus, for a wavelength of λ₁, only a laser of that band can be used. Compare this to a conventional SONET system in which the fiber is wavelength agnostic, i.e. it can be specified as 13××or 15××nm, for instance. This additional constraint requires some extra level of bookkeeping and inventory control must be maintained, and this will incur as an operational cost.

Once λ₁ is associated with the fourth floor, an additional consideration is where the wavelength-selected transmitter should be located. One approach is to assume that the rapidly falling prices will motivate system vendors to provide line cards with wavelength bands specified. For example, there may be 5 colored versions (in fact there are several in today's product mix), corresponding to spectral bands A, B, C, D, and one for unspecified wavelengths. Thus, on installation, the fiber and gear associated with the fourth floor would be “red” modules, for example, corresponding to one of the wavelength bands. Another approach would be to separate the SONET gear from the OSP system: there could be transponders associated with the OSP to change wavelengths so that the SONET vendors would need to change nothing about their operations or products (and in fact could use the cheapest possible 13××short reach lasers), while the Outside Plant (OSP) crews would have the responsibility of making sure that the transponder had a red panel, for instance. This approach has the advantage of not changing the SONET equipment, but introduces another layer of network elements to be managed. Finally, along this line, there is the question of the location of the transmitter if a transponder approach were taken. Should it be near the CPE, at some intermediate closet, or should it be part of whatever common space is available in the basement? This final tack merges, at some point, into the “real” (vs. “virtual”) common space approach. In any case, the very small footprint of the WDM optics gives a great deal of flexibility in dealing with these issues.

A third issue relates to various failures over time, where a shared ring similar to that proposed by the invention will eventually have traffic from some users in each of the conduits. This is avoided in the conventional situation, in that each ring had one and only one conduit with “live” traffic. There may be consequences to this when it becomes desirable to roll customers off one of the fiber legs, and this is an issue that can be addressed at either the protocol level (i.e. reverting or non-reverting recovery) or at the network management level.

It will be understood by those skilled in the art that device technology is a critical issue from cost, deployment, and operations perspectives. For example, the illustrative examples depict 1×N devices, but it is anticipated that 2×2N or 4×4N devices may be utilized.

Among the architectural issues, one can imagine node bypass, so that there would be a hierarchy of wavelength super-bands, for example, each super-band serving one or some subset of the total number of buildings on the ring. This would allow buildings to be added to the rings in a transparent way. This could impose coherent crosstalk, wavelength assignment, and device technology limitations. Other architectures, such as that shown in FIG. 10, could use bi-directional links to trade more complicated optics for further fiber savings. (Note the change in R and T placement in the FTTF figures for clarity of wavelength tracing.) As shown in FIG. 10, there is depicted an architecture 1000 including LSO 1002 and FTTF 1004a . . . . 1004n, each with a transmitter/receiver pair. The LSO 1002 and FTTF 1004a . . . 1004n are respectively linked by a bi-directional feeder fiber schematically depicted at 1006 and 1008. The transmitter/receiver pairs operating at the first two wavelength assignments that carry the live traffic are coupled at multiplexer/demultiplexer 1010 to feeder 1006. Similarly, the live traffic to and from FTTF 1004a and 1004n passes over the feeder 1006 through the multiplexer/demultiplexer at 1012. The backup or protection traffic depicted by the dashed lines is communicated from the LSO 1002 and a multiplexer/demultiplexer 1014 to the feeder 1008. On the opposite side, the feeder 1008 connects to a multiplexer/demultiplexer 1016, which in turn is connected to transmitter/receiver pairs in FTTF 1004a and FTTF 1004n. In this case, wavelength assignments are used to simulate the normal functions of the SONET ring. From the standpoint of the terminal operations, the performance is identical: the boxes all function as if they were on a UPSR system.

In summary, the present invention enables the use of newly emerging low-cost WDM technology to share the feeder portion of protected rings (such as SONET rings) that are used in business access. This arrangement enables user terminal equipment to operate independently with regard to protection switches, and allows new customers to be easily added to the ring. The invention provides a solution intermediate between drawing more fiber to a building for new FTTF customers and the provisioning of multiplexing equipment in a building's common space.

The present invention has been shown and described in what are considered to be the most practical and preferred embodiments. It is anticipated, however, that departures may be made therefrom and that obvious modifications will be implemented by those skilled in the art.

1. A method of communicating between a local serving office and a plurality of customer premises equipment, comprising the steps of:
transmitting signals at wavelengths λ₁ to λₙ from the local serving office to a plurality of multiplexers;
multiplexing the signals from the local serving office;
receiving the multiplexed signals from the local serving office at a plurality of demultiplexers;
distributing the demultiplexed signals at wavelengths λ₁ to λₙ to a corresponding N working receivers associated with the customer premises equipment; and
symmetrically receiving signals at wavelengths λ₁ to λₙ from N working transmitters associated with the customer premises equipment at a plurality of multiplexers;
multiplexing the signals from the customer premises equipment;
receiving the multiplexed signals from the customer premises equipment at a plurality of demultiplexers; and
distributing the demultiplexed signals from the customer premises equipment at wavelengths λ₁ to λₙ to the local serving office, thereby forming a first ring carrying working traffic with two nodes connected to the local serving office and two nodes connected to the customer premises equipment.

2. The method of claim 1, further comprising the steps of:
directing protection traffic through a second ring with two nodes connected to the local serving office, and two nodes connected to the customer premises equipment.

3. The method recited in claim 2, wherein the signals communicated between the local serving office and the customer premises equipment are transmitted through a first transmission conduit carrying regular traffic and a second transmission conduit carrying the protection traffic.

4. The method recited in claim 3, further comprising the steps of:
detecting a failure affecting a link between a single user of the customer premises equipment and at least one of a multiplexer and demultiplexer in one of the rings connecting the local serving office to the customer premises equipment;
directing traffic to the affected customer premises equipment through the other of the rings connecting the local serving office to the affected customer premises equipment.

5. The method recited in claim 3, further comprising the steps of:
detecting a failure in a first transmission conduit for the first ring; and
directing traffic to the customer premises equipment through the second conduit between the local serving office and the customer premises equipment.

6. The method recited in claim 1, wherein the multiplexers and demultiplexers utilize wave division multiplexing.

7. The method recited in claim 6, wherein the multiplexers and demultiplexers operate in wavelength bands on the order of from about 5 to 10 nm in spectral width.

8. The method recited in claim 3, wherein new customer premises equipment is added by the step of linking a multiplexer and demultiplexer on each ring with a corresponding receiver and transmitter associated with the new customer premises equipment.

9. The method recited in claim 3, further comprising the step of subdividing the spectral width assigned to a particular user of the customer premises equipment.

10. A method of communicating between a local serving office and a plurality of customer premises equipment, comprising the steps of:
transmitting signals at wavelengths XI to X from the local serving office over a link to a plurality of multiplexers;
multiplexing the signals from the local serving office into a transmission conduit;
receiving the multiplexed signals at a plurality of demultiplexers;
distributing the demultiplexed signals at wavelengths λ₁ to λₙ to a corresponding N working receivers associated with the customer premises equipment; and
symmetrically receiving signals at wavelengths λ₁ to λₙ from the customer premises equipment at a plurality of multiplexers;
multiplexing the signals from the customer premises equipment into a second transmission conduit;
receiving the multiplexed signals from the customer premises equipment at a plurality of demultiplexers;
distributing the demultiplexed signals from the customer premises equipment at wavelengths λ₁ to λₙ to the local serving office, thereby forming a first ring carrying working traffic with two nodes connected to the local serving office and two nodes connected to the customer premises equipment; and
directing protection traffic through a second ring through a second transmission conduit with two nodes connected to the local serving office, and two nodes connected to the customer premises equipment.

11. The method recited in claim 10, further comprising the steps of:
detecting a failure affecting a link between a single user of the customer premises equipment and at least one of a multiplexer and demultiplexer in one of the rings connecting the local serving office to the customer premises equipment;
directing traffic to the affected customer premises equipment through the other of the rings connecting the local serving office to the affected customer premises equipment.

12. The method recited in claim 10, further comprising the steps of:
detecting a failure in a first transmission conduit for the first ring; and
directing traffic to the customer premises equipment through the second conduit between the local serving office and the customer premises equipment.

13. A method of connecting a plurality of customer premises equipment in a building to a local serving office, comprising the steps of:
forming a first ring for carrying working traffic with two nodes connected to the local serving office and two nodes connected to the customer premises equipment, each of the two nodes including at least one multiplexer and demultiplexer; and
forming a second ring for carrying protection traffic with two nodes connected to the local serving office and two nodes connected to the customer premises equipment, each of the two nodes including at least one multiplexer and demultiplexer.

14. The method recited in claim 13, wherein a multiplexer in one of the two nodes is connected to a plurality of transmitters associated with the local serving office, each transmitter adapted to operate in a specified wavelength band, and wherein a demultiplexer in one of the two nodes is connected to a plurality of receivers associated with the local serving office, each receiver adapted to operate in a specified wavelength band.

15. The method recited in claim 14, wherein a multiplexer in one of the two nodes is connected to a plurality of transmitters associated with N number of customer premises equipment, and a demultiplexer in one of the two nodes is connected to a plurality of receivers associated with N number of customer premises equipment.

16. The method recited in claim 13, further comprising the step of connecting additional customer premises equipment to the local serving office by connecting one of the two nodes of the first ring and one of the two nodes of the second ring to the additional customer premises equipment.
